(19) United States
(12) Patent Application Publication
(10) Pub. No.: US 2009/0100506 A1
(43) Pub. Date: Apr. 16, 2009

(54) System and Method for Managing Network Flows Based on Policy Criteria

(76) Inventors: Steve Whang, Northridge, CA (US); Phil Ghang, Calabasas, CA (US); Mounif Haffar, Simi Valley, CA (US)

Correspondence Address: Craig A. Hoersten, Intellectual Property Dept.;Alcatel Lucent, 3400 West Plano Parkway, MS LEGL2, Plano, TX, 75075, US

(21) Appl. No.: 11/870,694

(22) Filed: Oct. 11, 2007

(51) Int. Cl. H04L 12/26; G06F 21/00

(52) U.S. Cl. 726/4; 370/230; 726/1

(57) ABSTRACT

A policy-based network flow management system and method. In one embodiment, various policy conditions are configured based at least in part upon source network conditions and multi-layer information (e.g., Layer 2, Layer 3, and so on) associated with network traffic. Where network traffic from a content requester is determined to satisfy a policy condition, a corresponding policy action is effectuated, e.g., dropping the network traffic, forwarding the network traffic, redirecting the network traffic, or queuing the network traffic.

### FIELD

The present disclosure generally relates to communications networks. More particularly, and not by way of any limitation, the embodiments of the disclosure are directed to a system and method for managing network flows based on policy criteria.

### BACKGROUND

Traffic flow management techniques associated with switching and routing in communications networks are known. However, there exist several deficiencies and shortcomings in the state of the art solutions, some of which typically involve link aggregation with static Media Access Control (MAC) addressing. For instance, certain schemes are not capable of supporting failover mechanisms, in that where there is a case of functional server failure at a service provider, traffic flow is still forwarded to a port, thereby resulting in no inspection. Also, when there is a functional failure on one of multiple servers, some of the current solutions cannot detect the logical failure associated therewith. Certain solutions are not amenable to plug-and-play implementations; that is, where the MAC address of a router is changed or added, re-configuration of the MAC addressing scheme is required. Additionally, some of the current solutions do not support multiple services where there are two or more groups of servers with different server profiles. In such applications, typically one switch per server cluster is needed. Still further, the architecture of some of the current solutions does not support scalability, load balancing, or both.

### SUMMARY

In one aspect, an embodiment of the present disclosure is directed to a policy-based network flow management method. The claimed embodiment comprises: determining whether network traffic received from a requester satisfies a policy condition that is configured based at least in part upon one of a source network condition associated with the requester and multi-layer information associated with the network traffic; and responsive to the determining, applying a policy action corresponding to the policy condition, the policy action including at least one of dropping the network traffic, forwarding the network traffic, redirecting the network traffic, and queuing the network traffic.

Another embodiment of the present disclosure is directed to policy-based network flow management system, comprising: means for determining whether network traffic received from a requester satisfies a policy condition that is configured based at least in part upon one of a source network condition associated with the requester and multi-layer information associated with the network traffic; and means, operable to responsive to the determining, for applying a policy action corresponding to the policy condition, the policy action including at least one of dropping the network traffic, forwarding the network traffic, redirecting the network traffic, and queuing the network traffic.

A still further embodiment is directed to a network node, comprising: means for maintaining at least one pointer table associated with a plurality of policy application servers, wherein the policy application servers are grouped into clusters based on an access control list, the policy application servers operating to apply one or more policy actions with respect to network traffic generated by content requesters; means for polling the policy application servers to determine status of the policy application servers; and means for updating the at least one pointer table based upon the polling.

### BRIEF DESCRIPTION OF THE DRAWINGS

A more complete understanding of the embodiments of the present patent disclosure may be had by reference to the following Detailed Description when taken in conjunction with the accompanying drawings wherein:

FIG. 1 depicts an exemplary network environment wherein a policy-based network flow management functionality may be implemented according to one embodiment;

FIG. 2 is a flowchart of a scheme for effectuating policy-based network flow management in accordance with one embodiment;

FIG. 3 depicts a high level architectural diagram of a network node operable to effectuate a policy-based network flow management scheme in accordance with one embodiment;

FIG. 4 depicts a functional block diagram of a network node according to one embodiment of the present disclosure;

FIG. 5 is a flowchart of an embodiment of a policy-based network flow management scheme; and

FIG. 6 is flowchart of an embodiment associated with policy server cluster management for purposes of the present disclosure.

### DETAILED DESCRIPTION OF THE DRAWINGS

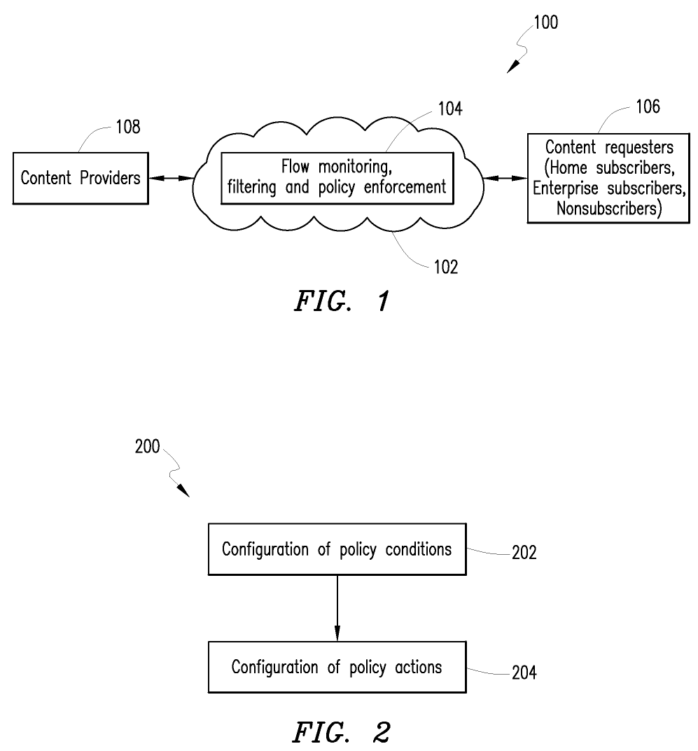

Embodiments of the present disclosure will now be described hereinbelow with reference to various examples. Like reference numerals are used throughout the description and several views of the drawings to indicate like or corresponding parts, wherein the various elements are not necessarily drawn to scale. Referring to FIG. 1 in particular, shown therein is an exemplary network environment 100 wherein a policy-based network flow management functionality may be implemented according to one embodiment. By way of illustration, network environment 100 is generalized to encompass any packet-based network infrastructure operable to support transactions between one or more content requesters 106 and one or more content providers 108, mediated via a suitable packet-switched network 102. In one implementation, the packet-switched network 102 may comprise a public network such as the Internet wherein the content providers 108 may comprise any number and/or type of web sites hosting a variety of content such as, e.g., data, multimedia (video/audio), etc. and the content requesters 106 may comprise users such as home subscribers, enterprise subscribers, non-subscribers. In another implementation, the packet-switched network 102 may comprise an Internet Service Provider (ISP) network mediating access services with respect to at least a portion of the content requesters 106. In yet another embodiment, the packet-switched network 102 may comprise an enterprise network (e.g., an Intranet) associated with an organization or enterprise wherein the content providers 108 may comprise internal repositories of various types of corporate data, with which corporate users, external requesters, or both may interact. Irrespective of the particular implementation of the network environment 102, a flow monitoring, filtering and policy enforcement functionality 104 is operably disposed between the content requesters 106 and the content providers 108, that may be generalized for purposes of the present patent disclosure as user side entities and network side entities, respectively. As will be described in further detail below, functionality 104 is operable to effectuate automatic traffic filtering, redirecting, and server load balancing (SLB) with respect to the transactions emanating from the user side entities based on multi-level and multi-factor policy conditions.

FIG. 2 is a flowchart of a scheme 200 for effectuating policy-based network flow management in accordance with one embodiment. A plurality of policy conditions may be configured (block 202) wherein a number of factors are considered for designing appropriate policies that can have versatile applicability. For instance, source network conditions, destination network conditions, Quality of Service (QoS) and/or Type of Service (ToS) requested, content/application type, size of packets, datagrams, or frames, port information (UDP/TCP port addresses), interface types, server status etc. may be engineered into policies ranging from relatively simple to relatively complex set of traffic rules. Source network conditions may include any number/type of identities or source addresses, e.g., Media Access Control (MAC) or Ethernet Hardware Addresses (EHAs), Internet Protocol (IP) addresses, and the like associated with a requester entity or source network. Likewise, destination network conditions may also include any number/type of identities or destination addresses (e.g., MAC/EHA or IP addresses) associated with a content provider entity or destination network.

Additionally, configuration of policy conditions (block 202) may also involve designing rules based on information associated with the network traffic itself. In accordance with one embodiment, policies may be implemented based at least in part upon the information associated with various layers of the Open System Interconnect (OSI) model of the traffic. For instance, certain types of policies may involve conditions based on header data and/or payload associated with Layer 2 (Data Link layer) frames, Layer 3 (Network layer) packets, Layer 4 (Transport layer), Layer 5 (Session layer), Layer 6 (Presentation layer), and Layer 7 (Application layer) segments of the network traffic emanating from the user side entities. Those skilled in the art will accordingly recognize that information associated with any combination of the OSI layers may be utilized in designing policies, in addition to combining the OSI-layer based policies with policies based on such other factors or criteria as described hereinabove to achieve even more complex set of rules.

A number of policy actions may be configured (block 204) that correspond with one or more configured policy conditions. In essence, policy actions may define various types of behavior to enforce appropriate balancing, scalability, filtering, failover mechanisms at a service provider with respect to the network traffic. For example, policy actions may comprise dropping the traffic, forwarding the traffic, redirecting the traffic, and so on. Policy actions may also involve routing based on the following: (i) one or more lists of interfaces through which the traffic can be routed; (ii) one or more lists of specified addresses; (iii) one or more lists of default interfaces; (iv) setting of precedential or preferential values based on ToS/QoS; and (v) setting of timeout values based on user profiles. Accordingly, based on determining whether the network traffic received from a content requester satisfies a policy condition, a suitable policy action corresponding to that policy condition may be applied with respect to the incoming traffic for purposes of the present patent application.

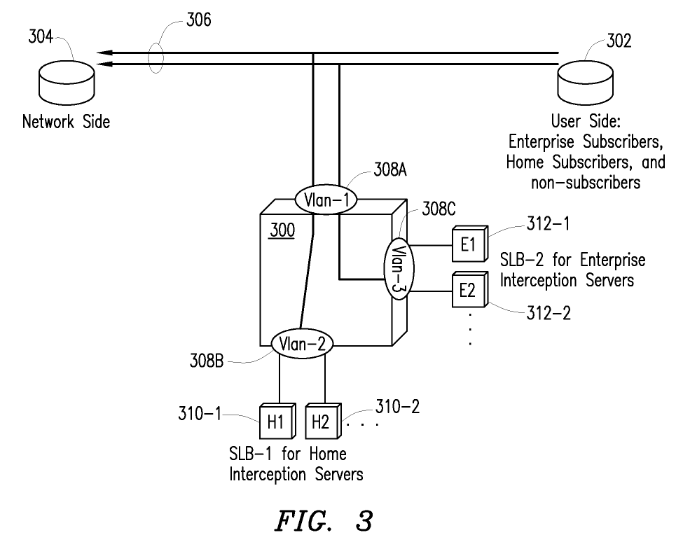

FIG. 3 depicts a high level architectural diagram of a network node 300 operable to effectuate a policy-based network flow management scheme in accordance with one embodiment. By way of illustration, reference numerals 302 and 304 refer to user side and network side entities, respectively, wherein the user side entity 302 may be representative of nodes (e.g., routers) operable to route network requests (i.e., traffic) 306 generated by users such as home subscribers, enterprise subscribers and non-subscribers, towards content providers via applicable next-hop nodes (e.g., routers) represented by the network side entity 304. In one exemplary implementation, the network node 300 may comprise an Ethernet switch operable to support multiple Virtual Local Area Network (VLAN) interfaces, each formed of a number of Ethernet ports. One of the VLAN interfaces, e.g., VLAN-1 308A, may be operatively coupled to the network paths in order to intercept the traffic flow 306 for purposes of effectuating policy-based flow management. Each of the remaining VLAN interfaces may be coupled to respective policy server clusters, wherein each cluster includes a plurality of policy or inspection servers based on suitable profiles, server load balancing and access control list (ACL)-based grouping. For purposes of the present disclosure, such clusters may be referred to as SLB clusters that enforce policy conditions and corresponding policy actions with respect to the incoming traffic, i.e., the network traffic generated by the user side entities. By way of example, VLAN-2 308B is coupled to SLB-1 cluster policy servers H1 310-1, H2 310-2, and so on. Likewise, VLAN-3 308C is interfaced with SLB-2 cluster policy servers E1 312-1, E2 312-2, and so on. An ACL mechanism may be provided such that a range of source addresses may be mapped to a corresponding SLB cluster. Accordingly, multiple ranges of source addresses (e.g., source IP address ranges or groups of network labels) may be mapped to corresponding SLB clusters. For instance, SLB-1 may be configured to receive incoming traffic only from home subscribers whereas SLB-2 may be configured to receive incoming traffic only from enterprise subscribers. Thus, an exemplary configuration scheme may involve the following: (i) configure SLB-1 cluster (without virtual IP addressing) for home subscribers; (ii) configure IP addresses of servers under SLB-1 cluster; (iii) configure SLB-2 cluster (without virtual IP addressing) for enterprise subscribers; (iv) configure IP addresses of servers under SLB-2 cluster; (v) configure policy conditions for home subscribers; (vi) configure policy conditions for enterprise subscribers; (vii) configure policy actions for a home subscriber redirected to SLB-1; (viii) configure policy actions for an enterprise subscriber redirected to SLB-2; and (ix) configure policy action(s) with respect to dropping network traffic. Accordingly, any network traffic (packets, frames or segments), which may belong to Layers 2, 3, or 4 and may comprise multicast, unicast or broadcast data, may be redirected to any VLAN based on any criteria while achieving availability, load balancing, scalability, and failover.

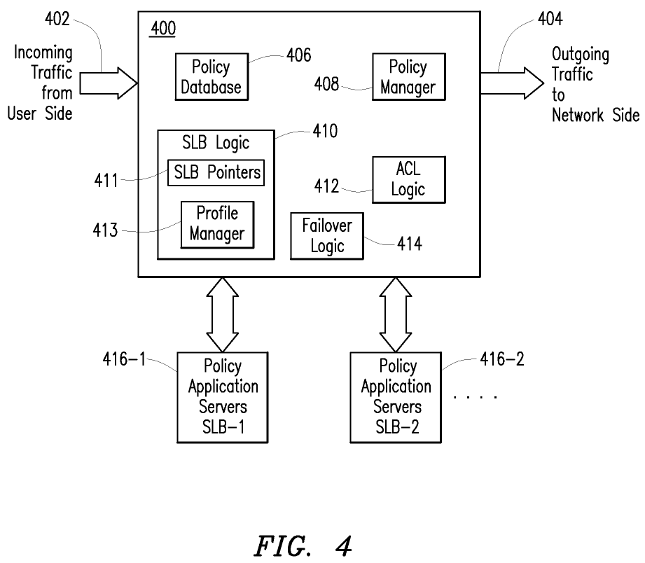

FIG. 4 depicts a functional block diagram of a network node 400 according to one embodiment of the present disclosure, wherein the functionality of network node 400 may generally be representative of the Ethernet switch 300 described above in some implementations. Reference numeral 402 refers to incoming traffic from user side entities and reference numeral 404 refers to outgoing traffic to network side entities. A policy database 406 may comprise various criteria for redirecting the traffic to appropriate SLB clusters, e.g., SLB-1 416-1 and SLB-2 416-2. A policy manager 408 is responsible for overall configuration, management and administration of the policy criteria. ACL logic 412 is provided for grouping SLB clusters based on source addresses, as alluded to previously. Failover logic 414 is operable with respect to each SLB clusters (each cluster having its own profile) such that efficient failover mechanisms may be implemented within a particular cluster. SLB logic 410 may comprise an SLB pointer table 411 and cluster profile manager 413 for monitoring the status of cluster servers.

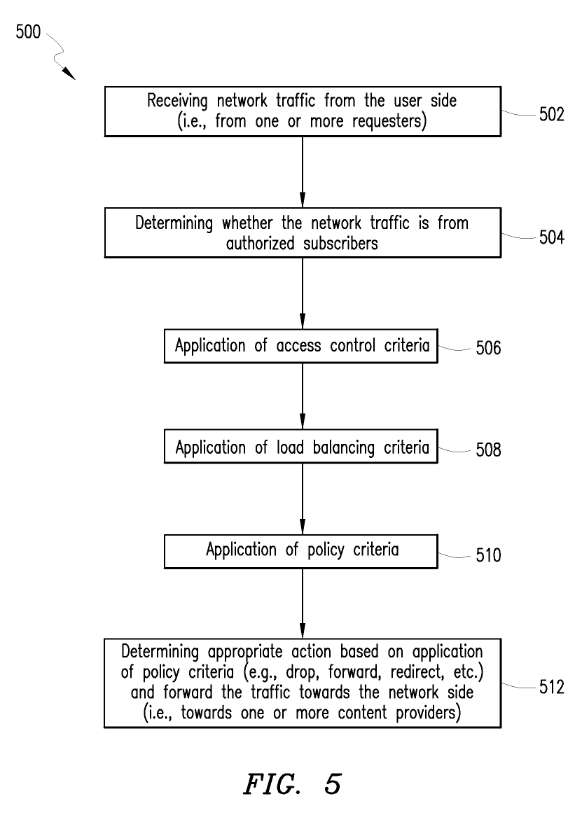

FIG. 5 is a flowchart of an embodiment of a policy-based network flow management scheme 500. At block 502, network traffic from the user side entities (i.e., one or more requesters) is received. An initial determination may be made, optionally, as to whether the network traffic is from authorized subscribers (block 504). If not, such traffic may simply be forwarded to appropriate destinations based on the destination address information. If the traffic is from authorized subscribers, on the other hand, suitable access control criteria may be applied (block 506) in order to determine to which SLB clusters such traffic may be redirected or queued. Optionally or additionally, suitable load balancing criteria may be applied (block 508) such that the load across a server cluster is fairly balanced. Policy criteria and conditions may be applied for determining appropriate policy actions (blocks 510 and 512) including, e.g., redirecting/queuing of the network traffic, as discussed above.

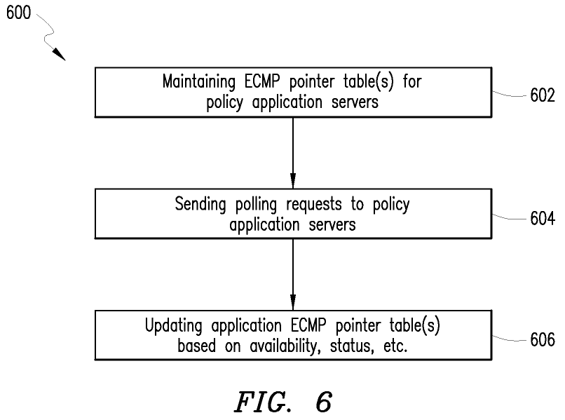

FIG. 6 is flowchart of an embodiment associated with policy server cluster management 600 for purposes of the present patent disclosure. As alluded to previously, SLB logic of a network node (e.g., network node 400) may involve maintaining one or more pointer tables with respect to the policy application servers associated therewith. In one implementation, SLB logic maintains an Equal Cost Multi-Path (ECMP) pointer table for the IP addresses of the configured servers (block 602). Polling requests may be transmitted to the policy application servers (block 604), e.g., periodically or based on the occurrence of certain events (server down, port failure, et cetera). Based on the responses received, applicable pointer tables are updated to account for availability status, load sharing, and the like (block 606).

It will be realized that policy service logic operable to effectuate the foregoing operations and determinations may be accomplished via a number of means, including software (e.g., program code), firmware, hardware, or in any combination, usually in association with a processing system associated with the network node. Where the processes are embodied in software, such software may comprise program instructions that form a computer program product, instructions on a computer-readable medium, uploadable service application software, or software downloadable from a remote station, and the like.

Based on the foregoing, it should be appreciated by those skilled in the art that the embodiments herein provide a solution where a policy service provider may achieve failover, plug-and-play multiple services capability, scalability, and fair load balance without the deficiencies and shortcomings set forth in the Background section. It is believed that the operation and construction of the embodiments of the present patent application will be apparent from the Detailed Description set forth above. While the exemplary embodiments shown and described may have been characterized as being preferred, it should be readily understood that various changes and modifications could be made therein without departing from the scope of the present disclosure as set forth in the following claims.

What is claimed is:

1. A policy-based network flow management method, comprising:
determining whether network traffic received from a requester satisfies a policy condition that is configured based at least in part upon one of a source network condition associated with said requester and multi-layer information associated with said network traffic; and
responsive to said determining, applying a policy action corresponding to said policy condition, said policy action including at least one of dropping said network traffic, forwarding said network traffic, redirecting said network traffic, and queuing said network traffic.

2. The policy-based network flow management method as recited in claim 1, further including determining whether said requester is an authorized subscriber.

3. The policy-based network flow management method as recited in claim 1, wherein said source network condition includes a source address associated with said requester.

4. The policy-based network flow management method as recited in claim 1, wherein said policy condition is further configured based on a destination network condition associated with a provider entity towards which said network traffic is directed.

5. The policy-based network flow management method as recited in claim 1, wherein said multi-layer information includes Open System Interconnect (OSI) Layer 1 information.

6. The policy-based network flow management method as recited in claim 1, wherein said multi-layer information includes Open System Interconnect (OSI) Layer 2 information.

7. The policy-based network flow management method as recited in claim 1, wherein said multi-layer information includes Open System Interconnect (OSI) Layer 3 information.

8. The policy-based network flow management method as recited in claim 1, wherein said multi-layer information includes Open System Interconnect (OSI) Layer 4 information.

9. A policy-based network flow management system, comprising:
means for determining whether network traffic received from a requester satisfies a policy condition that is configured based at least in part upon one of a source network condition associated with said requester and multi-layer information associated with said network traffic; and
means, operable to responsive to said determining, for applying a policy action corresponding to said policy condition, said policy action including at least one of dropping said network traffic, forwarding said network traffic, redirecting said network traffic, and queuing said network traffic.

10. The policy-based network flow management system as recited in claim 9, further including means for determining whether said requester is an authorized subscriber.

11. The policy-based network flow management system as recited in claim 9, wherein said source network condition includes a source address associated with said requester.

12. The policy-based network flow management system as recited in claim 9, wherein said policy condition is further configured based on a destination network condition associated with a provider entity towards which said network traffic is directed.

13. The policy-based network flow management system as recited in claim 9, wherein said multi-layer information includes Open System Interconnect (OSI) Layer 1 information.

14. The policy-based network flow management system as recited in claim 9, wherein said multi-layer information includes Open System Interconnect (OSI) Layer 2 information.

15. The policy-based network flow management system as recited in claim 9, wherein said multi-layer information includes Open System Interconnect (OSI) Layer 3 information.

16. The policy-based network flow management system as recited in claim 9, wherein said multi-layer information includes Open System Interconnect (OSI) Layer 4 information.

17. A network node, comprising:
means for maintaining at least one pointer table associated with a plurality of policy application servers, wherein said policy application servers are grouped into clusters based on an access control list, said policy application servers operating to apply one or more policy actions with respect to network traffic generated by content requesters;
means for polling said policy application servers to determine status of said policy application servers; and
means for updating said at least one pointer table based upon said polling.

18. The network node as recited in claim 17, wherein said access control list is operable to discriminate based on source address information associated with said content requesters.

19. The network node as recited in claim 17, wherein said content requesters include home subscribers.

20. The network node as recited in claim 17, wherein said content requesters include enterprise subscribers.

21. The network node as recited in claim 17, wherein said polling is performed periodically.

22. The network node as recited in claim 17, wherein each of said clusters is interfaced via a corresponding virtual local area network (VLAN) supported by said network node.
